(19) United States
(12) Patent Application Publication
(10) Pub. No.: US 2005/0002523 A1
(43) Pub. Date: Jan. 6, 2005

(54) Method and apparatus for mapping an input value to be mapped to an encrypted mapped output value

(75) Inventor: Steffen Marc Sonnekalb, Taufkirchen (DE)

Correspondence Address: DARBY & DARBY P.C., P. O. BOX 5257, NEW YORK, NY, 10150-5257, US

(73) Assignee: Infineon Technologies AG, Munich (DE)

(21) Appl. No.: 10/854,932

(22) Filed: May 26, 2004

(30) Foreign Application Priority Data
May 28, 2003 (DE) 103 24 422.0

(51) Int. Cl. H04L 9/00

(52) U.S. Cl. 380/28; 380/43

(57) ABSTRACT

An apparatus, which maps an input value to an encrypted mapped output value, which has a multiplexer with a control input, data inputs, and a data output for the encrypted mapped output value for through-connecting an encrypted data signal at one of the data inputs to the data output, and a provider that provides the encrypted data signals for the data inputs of the multiplexer based on an encryption key. A control signal indicating the output value to be mapped is applied to the control input of the multiplexer, and for every possible input value, which the input value to be mapped assumes, an output value is output at the data output of the multiplexer which can be derived from that possible output value by an encryption with the encryption key, to which the input value to be mapped is associated by the mapping regulation.

### CROSS-REFERENCE TO RELATED APPLICATION

This application claims priority to German Patent Application No. 10324422.0, which was filed on May 28, 2003, and is incorporated herein by reference in its entirety.

### BACKGROUND OF THE INVENTION

1. Field of the Invention

The present invention relates to mapping an input value to be mapped to an encrypted mapped output value, such as it occurs, for example, in sparkling encrypted S boxes in cryptography algorithms, such as the DES (Data Encryption Standard) or the AES (Advanced Encryption Standard).

2. Description of the Prior Art

In some cryptographic algorithms, so-called S boxes are used. Examples of such cryptographic algorithms are, for example, the DES (Data Encryption Standard) and AES (Advanced Encryption Standard) algorithms. FIG. 6 shows schematically the mode of operation of the DES algorithm. For encrypting the data, they are first divided into 64 bit blocks 900, to process them block by block. Then, the blocks 900 are first subjected to a permutation 902. Then, the permuted 64 bit data block is divided into two 32 bit data blocks 904 and 906. These 32 bit blocks 904 and 906 are iteratively subjected to the following operations in 16 so-called rounds. First, the content of the data 906, in FIG. 6 indicated by R, is mapped to the data 904 of the next round, which is indicated by L in FIG. 6. This mapping is represented by 908. To obtain the new content of the data block R 906 for the next round, the current content of the data 906 is subjected to an expansion operation E 910 to obtain a 48 bit data block from the 32 bit data block according to a pre-determined completing rule, according to which certain bits are doubled. In step 912, the 48 bit data block will then be encrypted by an XOR operation 912 with a 48 bit round key, which is different for every round but derived from the same 56 bit key 914 by an operation 916, which is not discussed in detail herein.

In the above-mentioned so-called S boxes S1, S8, the encrypted and expanded 48 bit data block is mapped again to a 32 bit data block. Therefore, every S box maps six different ones of the 48 bits of the encrypted data block to four bits, wherein the mapping regulations of the individual S boxes are mostly set by standards. After this S box mapping 918, the resulting value is again subjected to a permutation P 920 and thereupon, the permuted 32 bit block is subjected to an XOR operation 922, together with the 32 bit data block L 904 of the previous round. The XORed 32 bit data block represents the new 32 bit data block R 906 for the next round. This round defined by steps 908, 910, 912, 918, 920 and 922 is performed 16 times. After the 16 rounds, the resulting 32 bit data blocks L and R (904, 906) are again combined into a 64 bit data block and subjected to an output permutation 924 inverse to the permutation 922, whereby the final 64 bit output data block is obtained in encrypted form, which is indicated by 926.

Generally speaking, the S boxes represent an arbitrary and not necessarily unique mapping of an n bit vector to an m bit vector. In most cryptographic algorithms, mappings are not linear. The common implementation of an S box consists normally in a memory with an n bit input address and an m bit output date. Such an implementation of the S boxes is, however, extremely insecure against DPA attacks(DPA=differential power analysis). This can be illustrated with regard to the DES algorithm of FIG. 6 as follows. As has been mentioned above, the mapping regulations of the different S boxes are known. Additionally, in the power profile of the circuit executing the DES algorithm, every access is noticeable by certain characteristic waveforms, which correlate with the input addresses into the S boxes. Particularly in the DES algorithm it is dangerous that the input addresses introduced into the S boxes are encrypted with the secret round keys, which are derived from the secret main key 914 in a known manner, since it is mostly pre-determined by standards. For that reason it is possible to draw conclusions about the main key 914 from current profile analysis during the mappings 918 based on the correlation between the current profile of the circuit implementing the algorithm.

As has already been mentioned, the crypto algorithms DES and AES are not the only ones that encrypt data via S boxes. In all these algorithms, a differential current analysis enables an attack on secret data in the way described above. If unprotected S boxes are used for memory encryption in a micro-controller, even software crypto algorithms, which run on the processor and receive data from the encrypted memories, can be attacked via a DPA attack.

So far, this problem has not been solved in an adequate way. It is possible to increase the security against DPA attacks in this regard by the usage of a full custom dual rail circuit technique, but the usage of this circuit technique is connected to an extremely high effort which does not seem justified in all applications.

Therefore, it would be desirable to have a possibility to implement mappings, as such S boxes represent, in a way that enables higher security against spying out by DPA attacks in view of the processed values, with appropriate expenses.

### SUMMARY OF THE INVENTION

It is the object of the present invention to provide a method and an apparatus for mapping an input value to be mapped to an encrypted mapped output value, so that security against DPA attacks can be increased when using the mapping in a cryptography algorithm.

In accordance with a first aspect, the present invention provides an apparatus for mapping an input value to be mapped to an encrypted mapped output value according to a mapping regulation, by which a plurality of possible input values can be allocated to a plurality of possible output values, having a multiplexer means with a control input, a plurality of data inputs and a data output for the encrypted mapped output value for through-connecting an encrypted data signal at one of the data inputs to the data output; and a means for providing the encrypted data signals for the data inputs of the multiplexer means based on an encryption key, wherein the means for providing is formed such and a control signal indicating the output value to be mapped is applied to the control input of the multiplexer means, such that for every possible input value, which the input value to be mapped assumes, the multiplexer means outputs an output value, which can be derived from that possible output value by an encryption with the encryption key, to which the input value to be mapped is associated due to the mapping regulation.

In accordance with a second aspect, the present invention provides a method for mapping an input value to be mapped to an encrypted mapped output value according to a mapping regulation, by which a plurality of possible input values can be associated to a plurality of possible output values, based on a multiplexer means with a control input, a number of data inputs and a data output for the encrypted mapped output value, for through-connecting an encrypted data signal at one of the data inputs to the data output, comprising: providing the encrypted data signals for the data inputs of the multiplexer means based on an encryption key; and applying a control signal indicating an output value to be mapped to the control input of the multiplexer means, wherein providing and applying are performed such that for every possible input value, which the input value to be mapped assumes, the multiplexer means outputs an output value at the data output of the multiplexer means, which can be derived from that possible output value by an encryption with the encryption key, to which the input value to be mapped is associated by the mapping regulation.

The present invention is based on the knowledge that for increasing the security against DPA attacks, the correlation between input data to be mapped and the resulting current profile in an apparatus for mapping the input value to be mapped to encrypted mapped output value can be decreased by forming the mapping apparatus from a combination of a multiplexer means, at the control input of which a control signal indicating appropriately the input value to be mapped is applied, and a means for providing encrypted data for the data inputs of the multiplexer means based on an encryption key, wherein the means for providing is formed such and the control signal indicating appropriately the input value to be mapped is applied to the control input such that for every possible input value, which the input value to be mapped can assume, an output value is output at the output of the multiplexer means, which can be derived by an encryption with the encryption key from that possible output value to which the input value to be mapped is associated due to the mapping regulation.

This is based on the consideration that by providing the multiplexer means, the encryption of the output value mapped according to the mapping regulation to the encrypted mapped output value can be virtually be given priority prior to the actual through-connection procedures and prior to the actual through-connection procedure in the multiplexer means, respectively, which depends on the input value to be met, so that all switching procedures reflected in the performance profile can be performed in the multiplexer means on the basis of already encrypted data signals.

Specific embodiments of the present invention combine the encryption with the encryption key by using specific crypto multiplexer cells, which can be combined into a multiplexer means in the form of a binary multiplexer tree, and enable by their structure that the control signal appropriately indicating the value to be mapped can be encrypted with an arbitrarily varying key, before the control signal is used for performing the through-connection procedures, without the encryption of the control signal having an effect on the selection of the data input, which the multiplexer means constructed in that way switches to the data output. In that way, the correlation between current profile on the one hand and the input values to be mapped to the other hand is completely destroyed, since the through-connection procedures are only performed with encrypted data.

### BRIEF DESCRIPTION OF THE DRAWINGS

These and other objects and features of the present invention will become clear from the following description taken in conjunction with the accompanying drawings, in which:

FIG. 1 is a block diagram of a general embodiment of a mapping apparatus according to the present invention;

FIGS. 2a and 2b are circuit diagrams for two embodiments of a crypto multiplexer cell;

FIG. 3 is a block diagram of an encrypted 3-to-1 S box according to an embodiment of the present invention;

FIG. 4 is a block diagram of an encrypted 3-to-1 S box according to a further embodiment of the present invention;

FIG. 5 is a block diagram of a simplified encrypted 3-to-1 S box according to a further embodiment of the present invention; and

FIG. 6 is a diagram for illustrating the DES algorithm.

### DESCRIPTION OF THE PREFERRED EMBODIMENTS

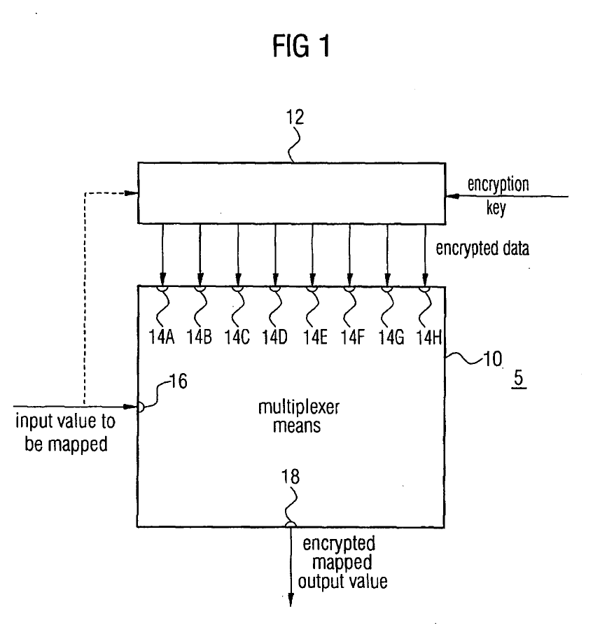

FIG. 1 shows a general embodiment of an apparatus for mapping an input value to be mapped to an encrypted mapped output value. The apparatus, generally indicated by 5, comprises a multiplexer means 10 as well as a means for providing encrypted data 12. The multiplexer means comprises eight data inputs 14a-14h, a control input 16 and a data output 18. As is shown, a signal indicating the input value to be mapped is applied to the control input 16 in an appropriate way explained in more detail below. Particularly, the signal indicating the input value to be mapped is either applied completely at the control input 16, so that the same alone indicates the input value to be mapped, or the signal applied to the control input indicates the input value to be mapped uniquely only together with a second signal indicated by a dotted line in FIG. 1, wherein the latter second signal is received by the means for providing 12. In any case, means 12 receives an encryption key.

After the structure of the apparatus 5 of FIG. 1 has been described above, its mode of operation will be described below.

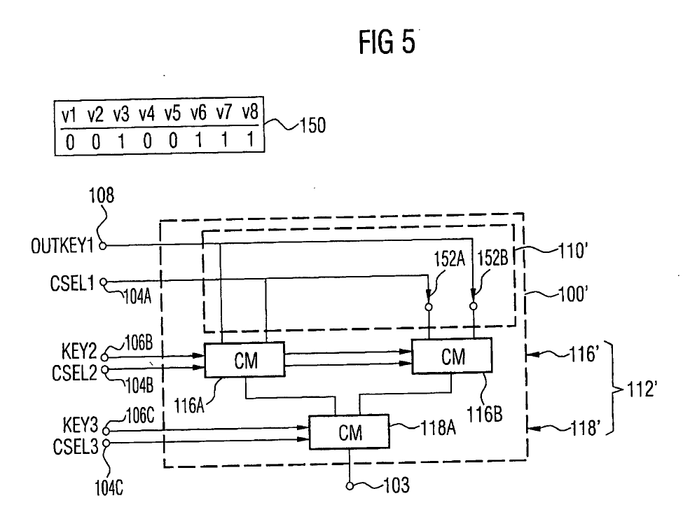

It is the purpose of the mapping apparatus of FIG. 5 to map an input value to be mapped to a mapped output value according to a mapping regulation, which is associated to apparatus 5, but to output an encrypted mapped output value instead of the mapped output value, which results from the mapped output value by an appropriate encryption with the encryption key.

The control signal received at the control input 16 is used by the multiplexer means 10 to connect through a signal applied at the data inputs 14a-14h to the data output 18. Preferably, there is a unique allocation between the data input to be connected through and the received control signal at the control input 16. However, it can also be the case that two different control signals effect that one and the same data input and the signal at one and the same data input, respectively, are connected through to the data output 18.

The means for providing 12 is formed to apply appropriately encrypted data to the data inputs 14a-14h of the multiplexer means depending on the encryption key, such that by considering the allocation of the data input to be connected through to the possible control signals at the control input 16 independent of the fact, to which of the possible input value the input value to be mapped corresponds, the resulting encrypted mapped output value always results from an encryption with the encryption key from the possible output value, which the mapping regulation allocates to the input value to be mapped.

As can be seen from the subsequent embodiments, there are different possibilities for realizing the mode of operation shown in FIG. 1. According to one of them, a control signal completely indicating the input value to be mapped is applied to the control input 16 of the multiplexer means 10. Then, the multiplexer means 10 selects one of the data inputs 14a-14h based on the input value to be mapped and connects it and the signal applied thereto, respectively, to the data output 18. Then, the means for providing 12 applies appropriate encrypted data to the data inputs 14a-14h. For the case that no encryption by the encryption key is to be present, the means for providing 12 will apply, such data to the data inputs 14a-14h, that at every data input that possible output value is applied, which is associated to that possible input value according to the mapping regulation, which the multiplexer means connects through to the data output upon this input value.

In an alternative case, the input value to be mapped is indicated in a unique way only by two partial signals together, wherein merely one partial signal is applied to the control input 16 of multiplexer means 10 as control signal, while the other partial signal is used by means for providing 12. In this case, the multiplexer means 10 is simplified, since the number of possible control signals at the control input 16 is reduced. In this case, the means for providing 12 used the partial signal it receives together with the encryption key to apply appropriately encrypted data to data inputs 14a-14h, as it will be discussed below exemplarily with reference to FIG. 5.

It is the advantage of the arrangement according to FIG. 1 that already encrypted data pass through the multiplexer means 10 with its internal through-connection procedures, and that, consequently, the correlation between the input value to be mapped to the one hand and the current profile effected by the multiplexer means 10 on the other hand is reduced, whereby DPA or SPA attacks to one of the crypto circuits containing this mapping apparatus are made more difficult.

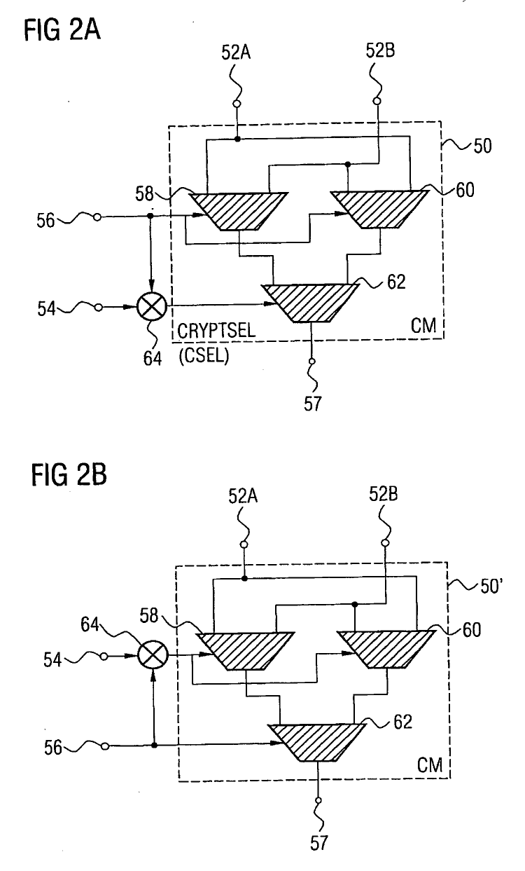

The specific embodiments described below with reference to FIGS. 2 and 5 combine the encryption by the encryption key prior to applying the encrypted data to the data inputs of the multiplexer means with a sophisticated design of the multiplexer means 10, so that the internal through-connection procedures of the multiplexer means 10 are performed on the basis of an also encrypted input value to be mapped. Particularly, for the structure of the multiplexer means, a crypto multiplexer means is used, two embodiments of which will be discussed below with reference to FIGS. 2a and 2b.

Before embodiments of the present invention will be discussed below in more detail with reference to the accompanying figures, it should be noted that the same elements in these figures are provided with the same reference numbers, and that a repeated description of elements repeating in the figures is omitted.

FIG. 2a shows a possible crypto multiplexer cell, which outputs one of two data signals at two data inputs at a data output depending on a control signal, wherein it is made more difficult to derive the control signal by a DPA attack, since the control signal is encrypted prior to its usage, as will be described below.

The crypto multiplexer cell of FIG. 2a, which is generally indicated by 50, has a first data input 52a, a second data input 52b, a control input 54, a key input 56 and a data output 57. The crypto multiplexer 50 comprises three elementary multiplexers 58, 60 and 62. Further, it has an associated XOR gate 64, as it is illustrated in the figure.

Each of the elementary multiplexers 58, 60 and 62 comprises two data inputs, a control input and a data output. A first, in FIG. 2a a left data input of the elementary multiplexer 58 is connected to the first data input 52a of the multiplexer cell, while the second, in FIG. 2a the right data input of the elementary multiplexer 58 is connected to the second data input 52b of the multiplexer cell 50. The second elementary multiplexer 60 is structured functionally equal to the elementary multiplexer 58, wherein, however, its data inputs are connected to the data inputs 52a and 52b of the crypto multiplexer cell 50 in an opposite way. Thus, a first, in FIG. 2a a right data input is connected to the second data input 52b of the multiplexer cell 50, while a second, in FIG. 2a the right data input of the elementary multiplexer 60 is connected to the first data input 52a of the multiplexer cell 50. Both elementary multiplexers 58 and 60 are connected with their control input to the key input 56 of the multiplexer cell 50. The outputs of the elementary multiplexers 58 and 60 are respectively connected to a different one of the data inputs of the elementary multiplexer 62. The output of the elementary multiplexer 62 forms the data output 57 of the multiplexer cell 50. The control input of the elementary multiplexer 62 is connected to an output of the XOR gate 64. The XOR gate 64 comprises two inputs, wherein a first input is connected to the key input 56 and the second input to the control input 54 of the elementary multiplexer 50.

After the structure of the crypto multiplexer cell 50 of FIG. 2a has been described above, which is also indicated by CM (crypto multiplexer), its mode of operation will be described below. The crypto multiplexer cell 50 is provided to connect through one of two data signals, which are applied to the data inputs 52a and 52b to the data output 57, or to output it there, respectively, depending on a control signal at the control input 54. In order to make the contribution of the crypto multiplexer cell 50 to the current profile of a circuit, into which it is installed, as independent as possible from the control signal at the control input 54, in order to protect the same from spying out by DPA attacks, the control signal is encrypted by a key applied to the key input 56 prior to its usage when connecting through.

All signals, i.e. key, control signal, the data signals at the data inputs 52a and 52b and the data signal at the data output 57 are presently binary signal and bit signals, respectively, which can assume one of two logic states, i.e. logic high or logic low.

For illustrating, why the encryption of the control signal at the control input 54 prior to its usage for connecting through is not negatively affecting the result of the through-connection, so that at the data inputs 52a and 52b the wrong data signal is connected through to the output 57, first, the mode of operation of the elementary multiplexer 62 in the output and terminal stage, respectively, will be considered. In the case where the key at the key input 56 has a logic low state, below sometimes referred to as 0, the encrypted control signal, which the XOR gate 64 outputs at the control input of the elementary multiplexer 62 and which is referred to as cryptsel in FIG. 2a, corresponds to this last mentioned control signal at the control input 54, independent of the respective current state of the control signal to be encrypted at the control input 54. Depending on the state of the control signal at the control input 54, consequently, the elementary multiplexer 62 selects the left or right one of its data inputs and connects the signal at the same through to the output 57.

If, however, the key at the key input 56 is logic high, the encrypted control signal, which the XOR gate 64 outputs to the control input of the elementary multiplexer 62, namely cryptsel, to the inverse of the control signal at the control input 54, independent of the respective state of the control signal at the control input 54. Consequently, the elementary multiplexer 62 selects in that case, i.e. the case where the key at the key input 56 has a logic high state, the data input, different to the case when the key has a logic low state, and connects this one through to the output 57.

To avoid an error in the output result of the crypto multiplexer 50 effected thereby, the further elementary multiplexers 58 and 60 are provided. Both obtain at their control input the key at the key input 56 as control signal. Since they are structured functionally equal, both of them, select the same data input among their data inputs, depending on the key, and connect the signal at the same through to their output, such as the left one of their data inputs when the key is 0. Since, however, their data inputs are connected in an opposite way to data inputs 52a and 52b of the crypto multiplexer cell 50, they effectively output a different one of the data signals at the data inputs 52 and 52b.

Also, the elementary multiplexers 58 and 60 output different ones of the data signals at the data inputs 52a and 52b in the case where the key 56 has the other state, for example a logic high state. Compared to the previous case, however, the elementary multiplexers 58 and 60 respectively output the other data signal in that case. Consequently, depending on the state of the key 56, the way how the two data signals, which are applied to the data inputs 52a and 52b of the multiplexer cell 50, are applied to the data inputs of the elementary multiplexer 62, changes. Exactly this conversion, however, corrects the above-described change in the selection of the data input, which the elementary multiplexer 62 selects among its data inputs for outputting it at its output depending on the state of the key and the key input 56. In this way, independent of the state of the key at the key input 56, always that data signal at the data inputs 52a and 52b is connected through to the data output 57, which is applied to the data input 52a and 25a, respectively, as it is indicated by the control signal at the control input 54, which means, for example, the signal at the input 52a at control signal=0 and the signal at the input 52b at control signal=1, independent of the key at input 56.

By the illustrated structure of three two-input elementary multiplexers 58, 60 and 62 shown in FIG. 2a it is ensured that none of these elementary multiplexers is controlled by the possibly secret control signal at the control input 54. In an inherent way, the structure ensures that the elementary multiplexers 58 and 60 operate independently from the elementary multiplexer 62 in terms of current. Thus, DPA attacks are made much more difficult, since the degree of correlation between occurring current profile and control signal is reduced.

Since the key at the key input 56 has no influence on the result at the data output 57, it can be constantly varied, such as by a random generator or another variation means.

In FIG. 2b, a crypto multiplexer cell 50′ modified from the crypto multiplexer cell 50 of FIG. 2a, is illustrated. It has the same components as the crypto multiplexer cell of FIG. 2a. Therefore, the same reference numbers as in FIG. 2a were used. The embodiment of FIG. 2b differs from the one of FIG. 2a merely with regard to applying the control signals to the elementary multiplexers 58-62.

Again, the two inputs of the XOR gate 64 are connected to the key input 54 and the control input 56, respectively, of the cell 50′. The output, where the XOR gate 64 outputs the encrypted control signal, however, is this time connected to the control inputs of the elementary multiplexers 58 and 60. The control input of the elementary multiplexer 62, i.e. the elementary multiplexer of the output stage in contrary to the input stage formed by the elementary multiplexers 58 and 60, is connected to the key input 56. Similar considerations as above with regard to FIG. 2a show that an altered applying of the pair of data signal to the data inputs of the elementary multiplexer 62 effected by the encryption of the control signal to the control input 54 is corrected by applying the key as control signal at the control input of the elementary multiplexer 62, so that again independent of the fact which state the key 56 has, always that data signal at the data inputs 52a and 52b is connected through to the data output 57, which corresponds to the respective state of the control signal at the control input 54.

With reference to the previous description, it should be noted that it is not necessarily required that the three elementary multiplexers 58, 60 and 62 have an identical structure. For example, an inverter can be provided to invert the control signal to one of the elementary multiplexers 58 and 60 in contrary to the control signal of the respectively different one, wherein the data inputs of the cell can then be connected in an appropriate way to the data inputs of the elementary multiplexers 58 and 60. Such a structure would mostly correspond to the above description, if, in such a case, inverter and multiplexer together are seen as an elementary multiplexer according to the above description.

The above embodiments concerned a simple embodiment, where the mentioned signal were merely bit signal and the multiplexer cells merely performed a 2-to-1 through-connection, respectively. Of course, different embodiments with multi-bit signals and correspondingly different encryption than the mentioned XOR encryption are possible.

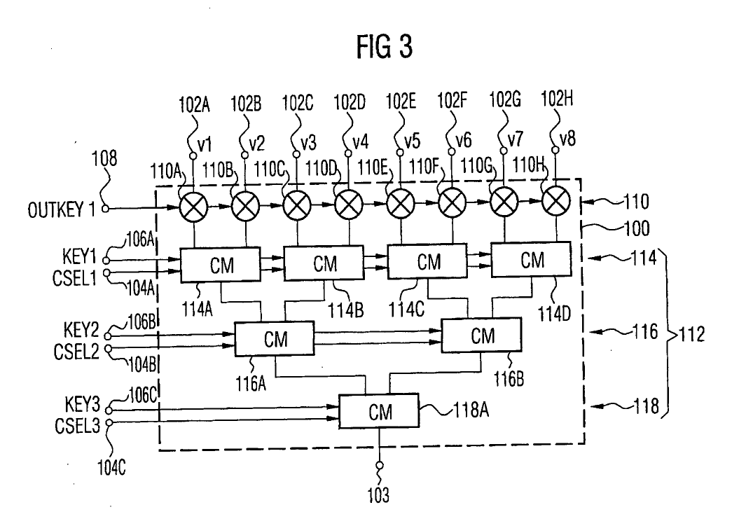

After two embodiments have been described above for a crypto multiplexer cell, which makes it possible to connect through one of two signals to an output with increased security against DPA attacks depending on a secret control signal, in the following, embodiments for S boxes will be described with reference to FIGS. 3 to 5, which are constructed by using these crypto multiplexer cells, so that the same provide an increased security from spying out of information by DPA attacks about the address values input into the S box.

For ease of illustration, first, with reference to FIGS. 3-5, merely embodiments for a 3-to-1 S box are described, where a three-bit input value and address value, respectively, is mapped to a one-bit output value. Then, it is described how these embodiments can also be transferred easily to any other S box, for example to the 6-to-4 S boxes used in the DES method.

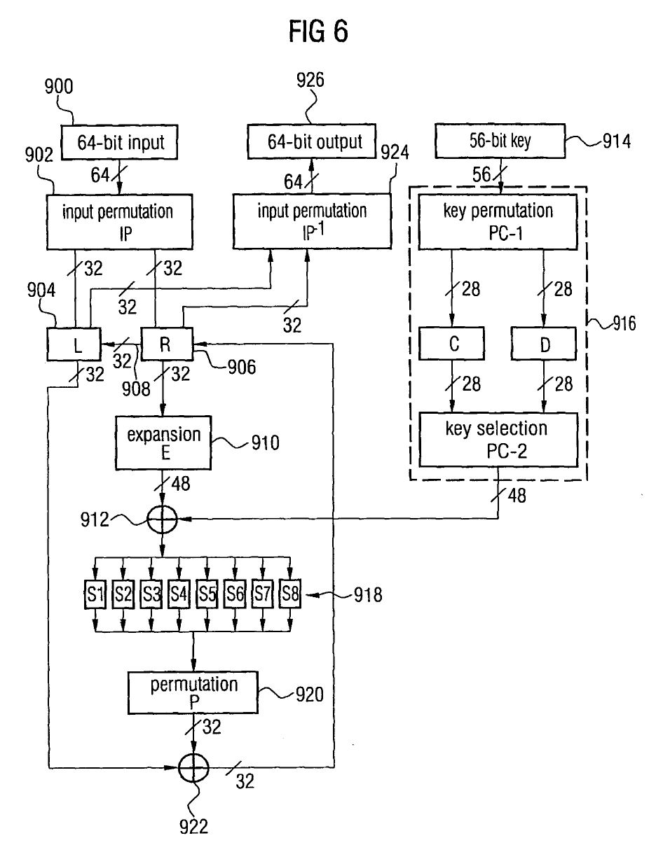

Before the embodiments for the S boxes will be discussed in more detail with reference to FIGS. 3-5, in the following, reference will be made briefly to FIG. 6 to illustrate where the problem lies when using the S boxes in the DES method with regard to DPA attacks, in order to be able to relate to this problem in the description of FIGS. 3-5.

As can be seen in FIG. 6, which has already been described in the introduction of the description, the S boxes and the mappings 918 defined thereby, respectively, are part of a DES round performed 16 times consisting of steps 908, 910, 912, 918, 920 and 922. In every round, an intermediate result, namely the extended data block after the expansion 910, is connected to a round key, which is derived from a main key 914, which is to be kept secret, in a known way 916. The operation is the XOR operation 912. The result encrypted in that way will be input into the S boxes S1-S8 portion- and 6-bit-wise, respectively. The mapping regulations of the S boxes are generally known due to the standardization of the DES algorithm.

The problem is now that during the processing of the encrypted data block after the operation 912 a current profile could result in the S boxes S1-S8, from which, via the DPA attack, conclusions can be drawn about the round keys and thus about the main key 914, which is to be kept secret. Therefore, an S box should always have a correlation as low as possible between current profile and address value to be mapped, here the encrypted data block after the operation 912.

FIG. 3 shows an embodiment of a 3-to-1 S box, which maps a three-bit input and address value, respectively, sel={sel1, sel2, sel3}, to an encrypted one-bit output value, which results from an output value determined by the mapping regulation underlying the S box via an XOR operation with an encryption bit outkey1.

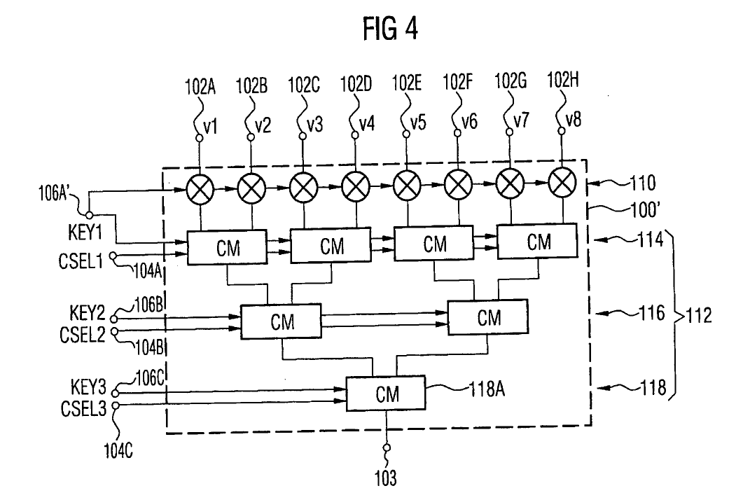

The S box of FIG. 3, which is generally indicated by 100, comprises eight data inputs 102a-102h, one data output 103, three control inputs 104a, 104b and 104c, which are indicated by csel, wherein “csel” is equal to “cryptsel” of FIG. 2a, three key inputs 106a, 106b and 106c as well as an encryption key input 108. Presently, a binary signal is present at every input, which is either logic high or logic low. The states of the signals at the data inputs 102a-102h define in a pre-determined way, which will result from the subsequent description, the mapping regulation of the S box 100, the same are fixed and are above that illustrated by v1-v8. As can be seen from the comparison of FIG. 3 and FIG. 2, the signal cryptsel (csel) is generated by an XOR gate (64 in FIG. 2a) not shown in FIG. 3 and FIG. 4, respectively, from the “Select” signal of FIG. 2a.

The signals csel1-csel3, which together form a unique bit representation of the three-bit input value sel, are applied to the three data inputs 104a-104c wherein presently, exemplarily, csel1 is the least significant and csel3 the most significant bit. The signals at the key inputs 106a-106c are indicated by key1-key3 and form together a unique bit representation of a 3-bit key, wherein again key1 is the least significant and key3 the most significant bit. The encryption key bit indicated by outkey1 is applied to the encryption key input 108.

Generally speaking, the S box 100 consists of an encryption part 110 and a multiplexer part and a multiplexer means 112, respectively. The encryption part 110 is formed by eight XOR gates 110a-110h. Every XOR gate has two inputs and one output. A first input of every XOR gate 110a-110h is connected to the encryption bit input 108. The second input of every XOR gate is connected to a different one of the eight data inputs 102a-102h.

The multiplexer part 112 is formed by a three-stage multiplexer tree of crypto multiplexer cells of the type of FIG. 2a or FIG. 2b (including the associated gates, such as 64 in FIG. 2a). Crypto multiplexer cells of a first and output stage, respectively, are indicated by 114a, 114b, 114c and 114d. Crypto multiplexer cells of a second stage of the multiplexer tree are indicated by 116a and 116b, while a crypto multiplexer cell of a terminated stage of the multiplexer tree is indicated by 118a. The stages of the multiplexer tree are generally indicated by 114, 116 and 118. The structure of the multiplexer tree, subsequently indicated by 112, is such that always the data outputs of the crypto multiplexer cells of a previous stage are connected to a respectively different one of the data inputs of the crypto multiplexer cell and the crypto multiplexer cells of the subsequent stage, respectively, so that the number of crypto multiplexers is divided in half from stage to stage. The control inputs of the crypto multiplexer cells are connected to a respectively different one of the control inputs 104a-104c. Particularly, the control inputs of the multiplexer cells 114a-114d of the input or beginning stage 114 are connected to the control input 104a of the S box 110, the control inputs of the multiplexer cells 116a and 116b to the control input 104b and the control input of the crypto multiplexer cell 118a with the control input 104c. In a respective manner, the crypto multiplexer cells of one stage are connected to same key input 106a-106c, which is, however, respectively different for a different stage.

Every XOR gate 110a-110h comprises an output. The output of every XOR gate 110a-110h is connected to a different one of the data inputs of the crypto multiplexer cells 114a-114d of the input stage of the multiplexer tree 112. The data output of the crypto multiplexer cell 118a of the output stage 118 is also the data output 103 of the S box 100.

After the structure of the S box 100 has been described above, in the following, its mode of operation will be described. First, the case is considered where the state of the encryption key bit outkey1 is logically low and 0, respectively. In this case, as can be seen from the following Table 1, the respective signal v1 . . . v8, as it is applied at the input of the respective XOR gate, can be output unchanged at its output.

TABLEe 1

| first input | second input | |
|---|---|---|
| (outkey1) | (v#) | output |
| 0 | 0 | 0 |
| 0 | 1 | 1 |
| 1 | 0 | 1 |
| 1 | 1 | 0 |

As a result, in the case of outkey1=0, consequently, the states V1-v8 are applied unchanged by the XOR gates to the data inputs of the crypto multiplexers 114a-114d.

One of these signals v1-v8 is connected through to the output 103 by the multiplexer tree 112, depending on the input value sel but independent of the key “key”. This will be illustrated below. As has been described above with reference to FIG. 2a-2b, every crypto multiplexer cell connects through one of the signals at its data inputs, depending on the control signal at the control input, to the output, independent of the state of the signal at the key input. Presently, the crypto multiplexers are exemplarily disposed such that at a logic low state of the control signal, i.e. 0, they connect through the left one of their data inputs at their control input to their output. The same applies for the other crypto multiplexer cells 116a, 116b and 118a. In that way, a unique allocation is defined between, on the one hand, the possible input values which the input value sel to be mapped can assume, and, on the other hand, the data inputs of the crypto multiplexer cells 114a-114d, which allocates a different one of these eight data inputs to any possible input value of sel, which is connected through to the output 102 by the multiplexer tree 112, when this input value is applied to the control inputs 104a-104c.

Under the above-made assumption about the structure of the crypto multiplexer cells and under the assumption that outkey1 equals 0, the allocation can be illustrated by the following Table 2, which shows, depending on values of sel1-sel3 (first three columns) for the case of outkey1=0, which of the signals v1-v8 is connected through to the output 103 (right column).

TABLE 2

| | | | mapped output |
|---|---|---|---|
| | | | value for |
| sel1 | sel2 | sel3 | outkey1 = 0 |
| 0 | 0 | 0 | v1 |
| 0 | 0 | 1 | v2 |
| 0 | 1 | 0 | v3 |
| 0 | 1 | 1 | v4 |
| 1 | 0 | 0 | v5 |
| 1 | 0 | 1 | v6 |
| 1 | 1 | 0 | v7 |
| 1 | 1 | 1 | v8 |

Consequently, a specific signal v1-v8 and a specific data input 102a-102h, respectively, is associated to every possible three-bit input value sel.

As has already been mentioned, every signal v1-v8 can merely take on one of two logic states. These are the possible two output values, which can be output at the output 103 of the S box 100. Which one of the two state the signals v1-v8 need to have depends on the desired truth table and the desired mapping regulation, respectively, of the S box 100. The states are therefore determined by the allocation as it results from Table 2, by respectively setting v1-v8 in Table 2 to the possible output value, i.e. 0 or 1, as it would correspond to the mapping regulation of the S box, which allocates a possible output value to each of the eight possible input values.

The previous discussion has shown that in the case of outkey1=0 the output value, which is set depending on the input value sel at the output 103 of the S box, is the one among the possible output values to which the respective input value to be mapped is mapped by the mapping regulation of the S box. By providing the crypto multiplexer cells, however, it is possible by varying the key “key” to mostly destroy the correlation between the current profile on the one hand and the input value sel on the other hand, so that DPA attacks are made more difficult.

A certain measure of correlation between input value sel to be mapped and the current profile still results merely due to the fact that the signals v1-v8 defining the mapping regulation are set in a fixed manner and that they are in a fixed allocation to the input value sel to be mapped. This correlation, however, will still be destroyed by the encryption key outkey1.

As will be discussed in more detail below, the encryption bit outkey1 effects that instead of the mapped output value in unencrypted form according to the mapping regulation of the S box according to the input value sel1-3 to be mapped, the same is output in encrypted form and thereby passes the multiplexer tree 112 in encrypted form. As a result, every correlation between current profile on the one hand and input value to be mapped sel1-3 on the other hand, can be destroyed by varying the encryption key outkey1, wherein merely the varying encryption of the output value with the key bit outkey1 has to be considered during the further processing.

In the present case, the encryption by the encryption part 110 is effected by a signal-wise XOR operation of the signals v1-v8 with the encryption bit outkey1. As a result, when outkey1 equals 0, as has been mentioned above, the output value resulting at output 103 corresponds to the output value to which the respective input value sel1-3 is mapped by the mapping regulation of the S box, i.e. the mapped output value. If outkey1 equals 1, as results from Table 1, each of the signals v1-v8 is inverted before it reaches the respective data input among the data inputs of the crypto multiplexer cells 114a-114d, where an output value results at the output 103 which is inverted to the output value which results at the same input value as sel1-3 in the case of outkey1. Consequently, the S box of FIG. 3 effects a mapping of an input value sel1-3 to an output value encrypted by XOR operation with the encryption bit outkey1 and mapped according to the mapping regulation.

By arbitrarily varying the encryption bit outkey1 as well as the three-bit key “key”, it is now possible to make the switching procedures in the crypto multiplexers completely independent of the input value sel to be protected from DPA attacks. This advantage will be described in more detail with reference to FIG. 6. First, with reference to FIGS. 4 and 5, further embodiments for a 3-to-1 S box are described, which are a variation of the S box of FIG. 3.

FIG. 4 shows a 3-to-1 S box 100′, which differs from the one shown in FIG. 3 merely by the fact that the key bit input has been combined with one of the control inputs of the S box, here exemplarily the control input 106a. This combined input is indicated in FIG. 4 by 106a′. As can be seen, in FIG. 4, the encryption bit input is exemplarily combined with the control input of the first stage 114 of the multiplexer tree 112, so that at the first inputs of the XOR gates of the encryption part 110 the least significant bit in the bit representation of the key “key”, i.e. key1, is applied as encryption bit. Of course it would also be possible to combine the encryption bit input with any other of the control inputs 106b and 106c.

The embodiment of FIG. 4 is simplified compared to the embodiment of FIG. 3 in that merely three bits, namely key1, key2 and key3 have to be varied to obtain the above-explained destruction of the correlation of the power consumption to the input values to be mapped.

FIG. 5 shows a further simplification of the embodiment of FIG. 3, wherein herein, the simplification is that the active encryption of the signals v1-v8 defining the mapping regulation prior to the first stage of the multiplexer tree used in the embodiment of FIG. 3 is replaced by a passive encryption by omitting the first stage of the multiplexer tree, according to which the encryption bit outkey1 and the least significant control bit sel1, in form and distribution appropriate, are applied individually to the data inputs of the next stage 116, wherein the fact is used that the signals v1-v8 representing the mapping regulation are known.

The embodiment of FIG. 5 represents a simplification of the S box in FIG. 3 for the exemplary case of a specific mapping regulation. More specifically, the S box 100″ of FIG. 5 represents a simplification of the S box of FIG. 3 for a mapping regulation, where the states of the signals v1-v8 assume the values listed in FIG. 5 at 115 respectively under v1-v8. As a result, FIG. 5 represent a 3-to-1 S box, which maps a 3-bit input value with the bits sel1, sel2 and sel3 with increasing significance to a one-bit output value according to the following mapping regulation and truth table, respectively, as long as outkey1 equals 0:

TABLE 3

| sel1 | sel2 | sel3 | output value |
|---|---|---|---|
| 0 | 0 | 0 | 0 |
| 0 | 0 | 1 | 0 |
| 0 | 1 | 0 | 1 |
| 0 | 1 | 1 | 0 |
| 1 | 0 | 0 | 0 |
| 1 | 0 | 1 | 1 |
| 1 | 1 | 0 | 1 |
| 1 | 1 | 1 | 1 |

The S box of FIG. 5 has a data output 103, three control inputs 104a, 104b and 104c, two key inputs 106b and 106c as well as an encryption bit input 108.

Generally, the S box 100″ consists of a data signal provision part 110′ as well as a multiplexer part 112′. The mulitplexer part 112′ corresponds to the last two stages of the multiplexer tree of FIG. 3 and the multiplexer tree of FIG. 3, respectively, without the input stage. Specifically, the multiplexer part 112′ consists consequently of a two-stage multiplexer tree with an input stage 116′ and an output stage 118′, wherein the input stage 116′ has two crypto multiplexer cells 116a and 116b, and the output stage has one crypto multiplexer cell 118a. The data outputs of the crypto multiplexer cells 116a, 116b are connected to the two data inputs of the crypto multiplexer cell 118a. The data output of the crypto multiplexer cell 118a forms the data output 103 of the S box 100″. The control inputs of the crypto multiplexer cells 116a, 116b are connected to the control input 104b, while the control input of the crypto multiplexer cell 188a is connected to the control input 104c. In a similar way, the key inputs of the crypto multiplexer cells 116a, 116b are connected to the key input 104b and the key input of the crypto multiplexer cell 118a to the key input 106c.

The data signal provision part 110′ consists mainly of traces, which are connected at one end to the encryption bit input 108 and the control input 104a, respectively, to distribute the signals applied thereto to the data inputs of the crypto multiplexer cells 116a, 116b of the input stage 116′ in an appropriate way. Inverters, here inverters 152a and 152b, are provided to invert the signals from the inputs 108 and 104a prior to their application to certain data inputs among the data inputs of the crypto multiplexers 116a, 116b. In the present case, the data signal provision part 110′ is formed such that at the left data input of the crypto multiplexer cell 116a the encryption bit, at the right data input of the crypto multiplexer cell 116a the least significant bit of the three-bit input value sel, i.e. sel1, at the left data input of the crypto multiplexer cell 116b the value of sel inverted by the inverter 152a, i.e. sel1 and at the right data input of the crypto multiplexer cell 116b the value of outkey1 inverted by the inverter 152b, i.e. outkey1, is applied. (The upper bar indicates the bit-wise inverse of the expression below).

This way of applying the data inputs of the crypto multiplexer cells 116a and 116b leads to the desired mapping regulation and the encryption of the output value 103 to be output under the assumption that it has already been used in the description of FIG. 3, namely that a control signal with the value 0 at a control input of one of the crypto multiplexer cells 116a-118a leads to connecting through the left data input to the respective data output, while a control signal of 1 leads to connecting through the signal to the right data input.

The considerations that lead to the application of the signals from the inputs 108 and 104a to the data inputs of the crypto multiplexers 116a and 116b will be discussed below. Starting point is the S box as illustrated in FIG. 3. There, the signals v1-v8 are determined by the mapping regulation of the S box 100″ in the way shown at 115. If the XOR gates 110-110h and the crypto multiplexer cells 114a-114d are examined in more detail, it can be seen that respectively one crypto multiplexer cell 114a-114d forms a unit together with its two connected XOR gates, whose value at the data output of the respective crypto multiplexer depends merely on the variables outkey1 and sel1, but not on key1, since this has no effect on the through-connection result of the crypto multiplexers and not on v1-v8, since the same are fixed and not variable.

Thus, in the case of v1 and v2, they are set to the fixed values 0 and 0. It can be seen from Table 1 concerning the XOR operation that outkey1 is applied to both data inputs of the crypto multiplexer cell 114a. Independent of the exact state of the signal sel1, consequently, the crypto multiplexer cell 114a outputs outkey1 to the left data input of the crypto multiplexer cell 116a of the subsequent stage 116. Similar considerations lead to the fact that the crypto multiplexer cell 114d definitely outputs the value outkey1 at its data output to the right data input of the crypto multiplexer cell 116b of the subsequent stage 116, since its associated signals v7 and v8 are both 1.

The case is different for v3 and v4. These signals have the values 1 for v3 and 0 for v4. Consequently, the values of v3 and v4 are inverted to each other. In the case of outkey1=0 the same are also applied in this form to the crypto multiplexer cell 114b. If the value of sel1 equals 0, the crypto multiplexer cell 114b selects the left data input, to which then the value v3=1 is applied. In the case of sel1=1 and outkey1=0, the cell 104b outputs 0. The case is exactly the opposite for the couple v5 and v6, which are applied exactly opposite to the pair v3 and v4 to the data inputs of the crypto multiplexer cell 114c, when outkey1 equals 0. In that way, the results that the crypto multiplexer cells 114b and 114c output at their respective data output to the subsequent crypto multiplexer cells 116a and 116b, respectively, can be represented by sel1 on the one hand and sel1 on the other hand.

The above considerations are generally applicable and can be applied to any mapping regulation and to any allocation of values to the signals v1-v8 and are again summarized in Table 4:

TABLE 4

| | | value to be output |
|---|---|---|
| | | to the data input |
| | | of the subsequent |
| | | crypto multiplexer |
| v odd | v even | cell |
| 0 | 0 | outkey1 |
| 1 | 1 | \overline{outkey1} |
| 1 | 0 | sel1 |
| 0 | 1 | \overline{sel1} |

When applying table 4, the structure of the data signal provision part 110′ results, as it is shown in FIG. 5. Since v1 and v2 are 0 and 0 in this case, the signal outkey1 is applied to the left data input of the crypto multiplexer cell 116a. The signal v3 v4 is 1 0, which is why, according to Table 4, the value sel1 is applied to the right data input of the crypto multiplexer cell 116a.

Consequently, the embodiment of FIG. 5 is a simplification of FIG. 3 in that less crypto multiplexer cells and no XOR gate are required. Otherwise, the mode of operation is the same.

Above, with reference to FIGS. 3-5, three embodiments for 3-to-1 S boxes have been described, which output a mapped output value depending on a 3-bit input value sel according to a mapping regulation, which made the possible eight input values, which the input value to be mapped could assume, namely {0 0 0}, {0 0 1}, {0 1 0}, {0 1 1}, etc., allocable to one of two possible output values, namely 0 or 1, wherein the mapped output value has been output in encrypted form, here in this case XORed with the encryption bit outkey1.

The S boxes of FIGS. 3-5 can easily be transferred to input values with more or less bit. In that way, 6-to-1 S boxes can be obtained easily. In order to get to the 6-to-4 S boxes required by the DES method, four 6-to-1 S boxes of the type of FIGS. 3, 4 or 5 are used. The key bits key# of every one of the four 6-to-1 S boxes can be identical or different to the key bits key# of the respective other one. In the same way, the encryption bit outkey1 can be the same for all these 6-to-1 S boxes. However, it is more secure when the encryption bit outkey# is different for every one of the four 6-to-1 S boxes, i.e. outkey1 for the first, outkey2 for the second, etc.

The mapping regulations of the four 6-to-1 S boxes could be derived from the total mapping regulation, which is to apply for the 6-to-4 S box, which is made up of the four 6-to-1 S boxes. The total mapping regulation maps 6-bit input values to 4-bit output values. Every bit of the four-bit output value is output by a 6-to-1 S box. Accordingly, the mapping regulation of every single 6-to-1 S box is determined from the total mapping regulation, which maps six to four bits, by the values in the respective bit position of the output value according to the total mapping regulation, which are to be output by the 6-to-4 S box.

This will be illustrated with a simple 3-to-2 S box case. If a 3-to-2 S box is to be generated with the mapping regulation illustrated in Table 5, two 3-to-1 S boxes have to be used together, one of which outputs the higher-order bit of the output value and has the mapping regulation of Table 6, and the second S box outputs the low-order bit of the two-bit output value and has the mapping regulation shown in Table 7.

TABLE 5

| | | | mapped out- |
|---|---|---|---|
| sel1 | sel2 | sel3 | put value |
| 0 | 0 | 0 | 00 |
| 0 | 0 | 1 | 01 |
| 0 | 1 | 0 | 10 |
| 0 | 1 | 1 | 00 |
| 1 | 0 | 0 | 01 |
| 1 | 0 | 1 | 11 |
| 1 | 1 | 0 | 10 |
| 1 | 1 | 1 | 11 |

TABLE 6

| | | | mapped out- |
|---|---|---|---|
| sel1 | sel2 | sel3 | put value |
| 0 | 0 | 0 | 0 |
| 0 | 0 | 1 | 0 |
| 0 | 1 | 0 | 1 |
| 0 | 1 | 1 | 0 |
| 1 | 0 | 0 | 0 |
| 1 | 0 | 1 | 1 |
| 1 | 1 | 0 | 1 |
| 1 | 1 | 1 | 1 |

TABLE 7

| | | | mapped out- |
|---|---|---|---|
| sel1 | sel2 | sel3 | put value |
| 0 | 0 | 0 | 0 |
| 0 | 0 | 1 | 1 |
| 0 | 1 | 0 | 0 |
| 0 | 1 | 1 | 0 |
| 1 | 0 | 0 | 1 |
| 1 | 0 | 1 | 1 |
| 1 | 1 | 0 | 0 |
| 1 | 1 | 1 | 1 |

When using a respectively combined 6-to-4 S box for the S boxes s1-s8 in the DES algorithm shown in FIG. 6, consequently, a DPE attacker could no longer draw conclusions about the secret input values and thus to the main key and the round key, respectively, due to the destruction of the correlation between the current profile effected by the through-connection procedures and the input values into the S boxes s1-s8. The output values of the S boxes are encrypted with the changing four-bit encryption key outkey1-outkey4.

With reference to the above description, it should be noted that it can be varied in different ways. Instead of the XOR operation used in the above figure description for encryption, further, an NXOR operation could be used. Further, the above description of the figures could easily be transferred to cases where the signals do not consist of one bit signal but of multi-bit signals. Thus, the signals v1-v8 could already be two-bit signals. In this case, the crypto multiplexer and the elementary multiplexer would have to be adapted in a way easily understood by a person skilled in the art, to connect through the bits of the 2-bit signals in pairs. In that case, a more complex encryption of the signals v1-v8 could be chosen.

With regard to the multiplexer part 112 it should be noted that the same does not have to be mad up exclusively of crypto multiplexer cells, but that the same can be made up in a mixed way of crypto multiplexer cells and elementary multiplexers up to the possibility that the tree is merely made up of elementary multiplexers. Further, several multiplexers could be combined to a more complex, maybe four-to-one multiplexer, up to the possibility that the whole multiplexer part 112 is formed of one, in the present embodiments an eight-to-one multiplexer.

Further, the embodiments of FIGS. 3-5 related to S boxes of the DES algorithm, but the embodiments can of course easily be transferred to other applications. Thus, the mapping apparatuses indicated there can also be used to implement a decoder, which also represents a mapping function, in a DPA or SPA safe way.

The embodiments described above with reference to FIGS. 3-5 represent randomized S boxes, which prevent DPA attacks on the cryptographic algorithms based thereon. In other words, they enable a DPA safe hardware implementation with semi-custom circuit technique, such as synthesis. By the randomized S box in connection with using the varying key “key” according to the sparkling circuit technique, it becomes possible to implement secure encryption algorithms into hardware easily, fast and with little effort. Both the secret key and the data, which is particularly important for memory encryptions, which are, for example, stored in memory, such as coefficients of software cryptography algorithms, can thus be protected efficiently from DPA and SPA attacks, respectively. The embodiments of the S boxes thus complete the sparkling circuit technique for DPA-safe processing of data, wherein the aim of the sparkling circuit technique is generally to subject used data or addresses with a temporarily changing random key, called sparkling key, to an XOR operation.

In the embodiments of the S boxes, any correlation between the data has been broken by consistent separation of the sparkling key (key) and the data (sel) encrypted thereby, and thus a DPA has been made impossible. Additionally, the sparkling technique has been used in the S boxes of FIGS. 3-5 in such a way that the sparkling-encrypted input data (sel) of the S boxes have been processed efficiently and without decrypting in the S boxes to determine the output values of the S boxes.

Furthermore, the output values of the S boxes are never processed in an unencrypted way and appear in the output of the S box provided with a further sparkling key (outkey).

That way it is made sure that no correlation of the data can be determined at any time and thus, a DPA attack is made impossible. Furthermore, the circuits of FIGS. 3-5 are simple and regular, wherein the latter characteristic enables the usage of a special cell on transistor level for area minimizing. They secure a non-mixing of the sparkling key outkey and the sparkling encrypted input data (sel) via a synthesis. The possible output data (v1-v8) are protected from the beginning by a sparkling key outkey1.

The multiplexer tree, which is made up of the crypto multiplexers, is the base of embodiments of FIGS. 3-5. The crypto multiplexer allows multiplexing of data across an encrypted control signal. In principle, it was made up of three simple two-input multiplexers. Herein, the data to be multiplexed are either switched by the sparkling key outkey1 or the sparkling control signal key1, in the way that one multiplexer is operated by the positive controlling signal and a second one with the inverted signal. Then, the third multiplexer within the crypto multiplexer selects the result of the first two multiplexers of the signal not used at the beginning (sparkling control signal or sparkling key). As long as the first two multiplexers are not merged with the third in one circuit, as it would, for example, happen automatically by a synthesis during the circuit design, the same operate current-wise independent of one another and the circuit is DPA-safe. In the synthesis, this can be ensured by a simple grouping of the gates, or it is possible to add a respective special cell of the cell library of the development environment and library, respectively, which has a high area potential.

As it has further been described, for an m-to-n S box, a multiplexer tree can be built up for any of the n output bits. In this tree, the output bit of a certain bit position of the output value is respectively selected for the input vector. This results in a binary tree. The input values of the S box, i.e. the values v1-v8 at the leaves of the tree itself are already encrypted at the beginning with a sparkling key (outkey1) and are thus passed on in an encrypted way through the whole tree. This allows no DPA of the output data of the S box. For load and circuit-technical reasons, i.e. for a balanced design, the control lines, on which the input data reach the S box, should be distributed input-capacitively for the different output bits, so that approximately an equal load is applied to every section bit and every control input, respectively. Since the output data, i.e. v1-v8, are fixed for the S box, the crypto multiplexer structure can be merged on the leaf level (input stage) of the tree, as has been described with reference to FIG. 5. Thereby, the embodiments of FIGS. 4 and 5 can be combined, when the sparkling key of the leaf level, i.e. key1, is also used as the sparkling key for the output bit (outkey1), i.e. outkey1=key1. Thus, the first stage can be reduced to a piece of line and an inverter, respectively. This halves the size of the multiplexer tree.

While this invention has been described in terms of several preferred embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An apparatus for mapping an input value to be mapped to an encrypted mapped output value according to a mapping regulation, by which a plurality of possible input values can be allocated to a plurality of possible output values, comprising:
a multiplexer, which has a control input, a plurality of data inputs and a data output for the encrypted mapped output value, that through-connects an encrypted data signal at one of the data inputs to the data output; and
a provider that provides encrypted data signals for each of the plurality of data inputs of the multiplexer based on an encryption key,
wherein the provider is formed such that a control signal indicating the output value to be mapped is applied to the control input of the multiplexer such that for every possible input value, which the input value to be mapped assumes, the multiplexer outputs an output value, which can be derived from that possible output value by an encryption with the encryption key, to which the input value to be mapped is associated by the mapping regulation.

2. The apparatus according to claim 1, wherein the control signal forms a clear representation of the input value to be mapped.

3. The apparatus according to claim 2, wherein the provider encrypts a data signal, which indicates a value selected from the group of possible output values with the encryption key for every data input of the multiplexer, to obtain an encrypted data signal for every data input and to output the encrypted data signals to the data inputs of the multiplexer.

4. The apparatus according to claim 3, wherein the provider performs an XOR or NXOR operation of the encryption key and the data signal as encryption.

5. The apparatus according to claim 1, wherein the provider applies an encrypted data to each of the data inputs of the multiplexer, which is selected from a group which comprises a bit of a bit representation of an input value to be mapped, whose other bits are uniquely indicated by the control signal, a bit inverted to the one bit of the bit representation, an encryption bit and an encryption bit inverse to the encryption bit.

6. The apparatus according to claim 5, wherein the selection from the group is such that for every possible input value, which the input value to be mapped assumes, the encryption with the encryption bit, by which the output value, which is output at the data output of the multiplexer for the respective possible input value, can be derived from that possible output value to which the respective possible input value is associated by the mapping regulation, is an XOR or NXOR operation of the encryption bit and that possible output value, to which the respective possible input value is associated by the mapping regulation.

7. A device for mapping an input value to be mapped to an encrypted mapped total output value according to a total mapping regulation, by which a plurality of possible input values can be associated to a plurality of possible total output values, with at least two apparatuses according to claim 1, wherein the encrypted mapped output values together provide a unique representation of the encrypted mapped total output value at the data outputs of the multiplexer.

8. The device according to claim 7, wherein the encryption keys of the at least two apparatuses are set independent of one another.

9. The apparatus according to claim 1, wherein the multiplexer is a multiplexer tree, which is made up of subsequent stages which comprise at least one input stage and one output stage, wherein the output stage comprises one and the other stages several multiplexers, wherein every multiplexer has a first data input, a second data input, a control input and a data output, wherein for every stage, the data output of the multiplexers of this stage is connected to a different one or different ones of the data inputs of the multiplexer of the subsequent stage of the multiplexer tree, and wherein the control inputs of the multiplexers within every stage are controlled by a respective control signal different for the stages.

10. A method for mapping an input value to be mapped to an encrypted mapped output value according to a mapping regulation, by which a plurality of possible input values can be associated to a plurality of possible output values, based on a multiplexer with a control input, a number of data inputs and a data output for the encrypted mapped output value, for through-connecting an encrypted data signal at one of the data inputs to the data output, comprising:
providing the encrypted data signals for the data inputs of the multiplexer based on an encryption key; and
applying a control signal indicating an output value to be mapped to the control input of the multiplexer,
wherein the providing and applying steps are performed such that for every possible input value, which the input value to be mapped assumes, the multiplexer outputs an output value at the data output of the multiplexer, which can be derived from that possible output value by an encryption with the encryption key, to which the input value to be mapped is associated by the mapping regulation.
